(19) United States
(12) Patent Application Publication
(10) Pub. No.: US 2017/0192590 A1
(43) Pub. Date: Jul. 6, 2017

(54) TOUCH DISPLAY APPARATUS

(71) Applicant: Samsung Display Co., Ltd., Yongin-si (KR)

(72) Inventors: Sanghyun LIM, Cheonan-si (KR); Changsub JUNG, Hwaseong-si (KR); Ara JO, Seoul (KR); Jaewoo CHOI, Seoul (KR)

(21) Appl. No.: 15/378,281

(22) Filed: Dec. 14, 2016

(30) Foreign Application Priority Data
Jan. 6, 2016 (KR) 10-2016-0001722

(51) Int. Cl. G06F 3/041; G02F 1/1362; F21V 8/00; G06F 3/044; G02F 1/1333

(52) U.S. Cl. CPC G06F 3/0416; G06F 3/044; G02F 1/13338; G02B 6/0055; G02B 6/0051; G02F 1/136286; G02B 6/0053; G06F 2203/04103; G02F 2201/123; G02F 1/134309

(57) ABSTRACT

A touch display apparatus includes a display panel, a receiving container and a touch controller. The display panel includes a metal pattern. The metal pattern includes a gate metal pattern and a data metal pattern. The gate metal pattern includes a gate line extending in a first direction. The data metal pattern includes a data line extending in a second direction crossing the first direction. The display panel is configured to display an image. The receiving container receives the display panel and includes a metal. The touch controller includes a first connecting line electrically connected to the metal pattern and a second connecting line electrically connected to the receiving container. The touch controller is configured to sense change of capacitance due to change of difference between the metal pattern and the receiving container.

### CROSS-REFERENCE TO RELATED APPLICATION

This application claims priority from and benefit of Korean Patent Application No. 10-2016-0001722, filed on Jan. 6, 2016, which is hereby incorporated by reference for all purposes as if fully set forth herein.

### BACKGROUND

Field

Exemplary embodiments of the present inventive concept relate to a touch display apparatus. More particularly, exemplary embodiments relate to a touch display apparatus for reducing a manufacturing cost thereof and decreasing a thickness thereof.

Discussion of the Background

As information technology develops, demand for various display apparatuses has increased. Accordingly, a liquid crystal display (“LCD”) apparatus, a plasma display panel (“PDP”), a field emission display (“FED”) apparatus, an electrophoretic display (“EPD”) apparatus, and an organic light emitting display (“OLED”) apparatus have been actively studied.

A touch screen panel function may be applied to the display apparatus. The touch screen panel is an input device for inputting instructions by touching the screen of the display apparatus with an input object such as a finger or a pen. The touch screen panel can be used as a substitute for an additional input device such as a keyboard or a mouse which is connected to the display apparatus so that the touch screen panel has been broadly used for improving user's convenience.

Generally, the touch screen panel can sense a pressure by sensing a change of capacitance due to change of distance between an electric conductor and a conductive means spaced apart from the electric conductor. Because of the distance between the electric conductor and the conductive means, the thickness of the display apparatus may increase.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a touch display apparatus for reducing the manufacturing cost of the touch display apparatus and decreasing the thickness of the touch display apparatus.

Additional aspects will be set forth in the detailed description which follows, and, in part, will be apparent from the disclosure, or may be learned by practice of the inventive concept.

An exemplary embodiment discloses a touch display apparatus that includes a display panel, a receiving container, and a touch controller. The display panel includes a metal pattern. The metal pattern includes a gate metal pattern and a data metal pattern. The gate metal pattern includes a gate line extending in a first direction and a gate electrode electrically connected to the gate line. The data metal pattern includes a data line extending in a second direction crossing the first direction, a source electrode electrically connected to the data line and a drain electrode spaced apart from the source electrode. The display panel is configured to display an image. The receiving container receives the display panel and includes a metal. The touch controller includes a first connecting line electrically connected to the metal pattern and a second connecting line electrically connected to the receiving container. The touch controller is configured to sense change of capacitance due to change of difference between the metal pattern and the receiving container.

An exemplary embodiment discloses a touch display apparatus that includes a display panel, a reflective sheet, and a touch controller. The display panel includes a metal pattern. The metal pattern includes a gate metal pattern and a data metal pattern. The gate metal pattern includes a gate line extending in a first direction and a gate electrode electrically connected to the gate line. The data metal pattern includes a data line extending in a second direction crossing the first direction, a source electrode electrically connected to the data line and a drain electrode spaced apart from the source electrode. The display panel is configured to display an image. The reflective sheet is disposed under the display panel. The reflective sheet is spaced apart from the display panel. The reflective sheet includes a metal. The touch controller includes a first connecting line electrically connected to the metal pattern and a second connecting line electrically connected to the reflective sheet. The touch controller is configured to sense change of capacitance due to change of difference between the metal pattern and the reflective sheet.

According to exemplary embodiments of the present disclosure, the touch display apparatus may include the touch driver and the touch controller including the first connecting line and the second connecting line. The first connecting line electrically connects the gate metal pattern or the data metal pattern which is formed on the display panel to the touch driver. The second connecting line electrically connects the receiving container or the reflective sheet to the touch driver. Thus, the touch driver may sense the change of the capacitor according to the change of the distance between the gate metal pattern or the data metal pattern and the receiving container or the reflective sheet.

Therefore, an additional electrode to sense the pressure may be omitted so that the thickness of the touch display apparatus may be decreased and the manufacturing cost of the touch display apparatus may be reduced.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is an exploded perspective view illustrating a touch display apparatus according to an exemplary embodiment of the present disclosure.

FIG. 2 is a cross-sectional view illustrating the touch display apparatus of FIG. 1.

FIG. 3 is a plan view illustrating a display panel of FIG. 1.

FIG. 4 is a cross-sectional view illustrating the display panel of FIG. 3 cut along a line I-I′ and a line II-II′ in FIG. 3.

FIG. 5, FIG. 6, FIG. 7, FIG. 8, and FIG. 9 are cross-section views illustrating a method of manufacturing the display panel of FIG. 3.

FIG. 10 is a plan view illustrating the display panel of FIG. 1.

FIG. 11 is a cross-sectional view illustrating the display panel of FIG. 10 cut along a line I-I′ and a line II-II′ in FIG. 10.

FIG. 12, FIG. 13, FIG. 14, FIGS. 15, and 16 are cross-section views illustrating a method of manufacturing the display panel of FIG. 10.

FIG. 17 is an exploded perspective view illustrating a touch display apparatus according to an exemplary embodiment.

FIG. 18 is a cross-sectional view illustrating the touch display apparatus of FIG. 17.

FIG. 19 is a plan view illustrating a display panel of FIG. 17.

FIG. 20 is a cross-sectional view illustrating the display panel of FIG. 19 cut along a line III-III′ and a line IV-IV′ in FIG. 19.

FIG. 21, FIG. 22, FIG. 23, FIGS. 24, and 25 are cross-section views illustrating a method of manufacturing the display panel of FIG. 19.

FIG. 26 is a plan view illustrating the display panel of FIG. 17.

FIG. 27 is a cross-sectional view illustrating the display panel of FIG. 26 cut along a line III-III′ and a line IV-IV′ in FIG. 26.

FIG. 28, FIG. 29, FIG. 30, FIGS. 31, and 32 are cross-section views illustrating a method of manufacturing the display panel of FIG. 26.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

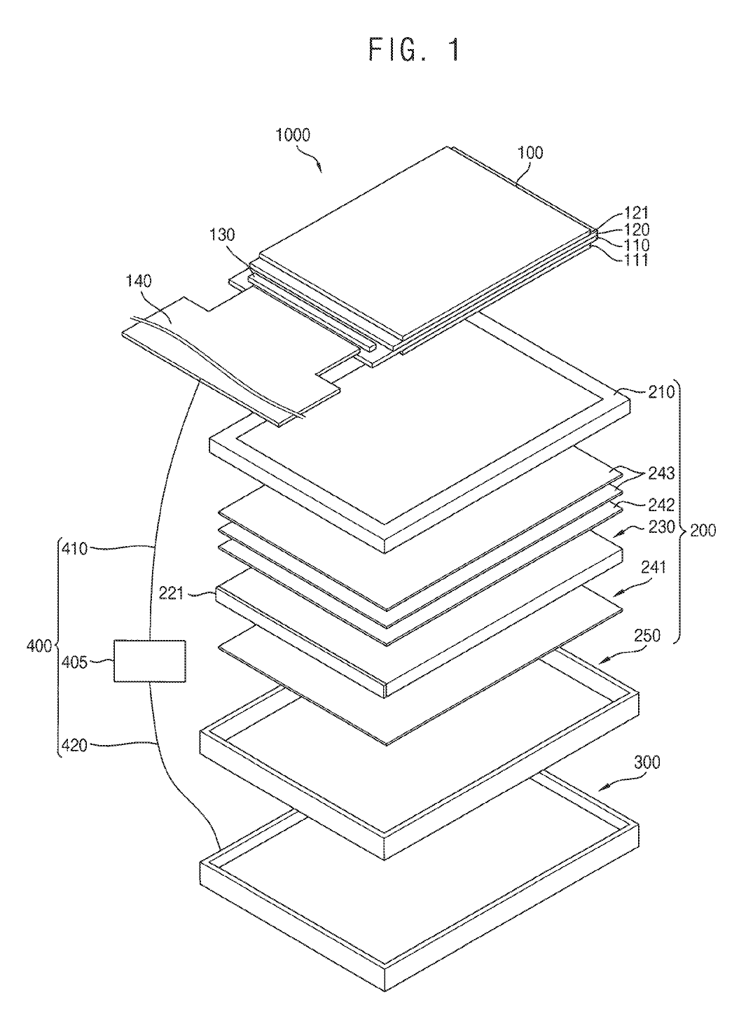

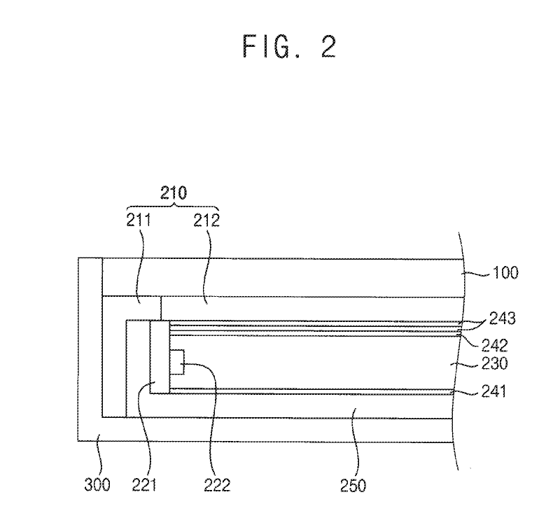

FIG. 1 is an exploded perspective view illustrating a touch display apparatus according to an exemplary embodiment of the present disclosure. FIG. 2 is a cross-sectional view illustrating the touch display apparatus of FIG. 1.

Referring to FIGS. 1 and 2, the display apparatus 1000 includes a display panel 100, a main flexible printed circuit board 140 electrically connected to the display panel 100, a backlight assembly 200 providing light to the display panel 100, a receiving container 300 and a touch controller 400.

The display panel 100 may include a first substrate 110, a second substrate 120 opposite to the first substrate 110, a liquid crystal layer (not shown) disposed between the first substrate 110 and the second substrate 120, a first polarizing film 111 disposed under the first substrate 110, and a second polarizing film 121 disposed on the second substrate 120. The display panel 100 displays an image using the light from the backlight assembly 200.

Thin film transistors (“TFT”s) which are switching elements may be formed in a matrix form on the first substrate 110. Source electrodes of the TFTs may be respectively connected to gate lines. Gate electrodes of the TFTs may be respectively connected to data lines. Drain electrodes of the TFTs may be respectively connected to pixel electrodes which include a transparent and conductive material.

The second substrate 120 may be opposite to the first substrate 110. RGB color filters to represent RGB colors may be formed on the second substrate 120. A common electrode including a transparent and conductive material may be formed on the second substrate 120. The common electrode may face the pixel electrodes of the first substrate 110.

When a signal is applied to the gate electrode of the TFT in the display panel 100, the TFT may be turned on. When the TFT is turned on, an electric field may be formed between the pixel electrode and the common electrode. Arrangement of liquid crystal molecules of the liquid crystal layer disposed between the first substrate 110 and the second substrate 120 may be changed by the electric field. According to the change of the arrangement of the liquid crystal molecules, light transmittance of the liquid crystal layer may be changed so that an image of a desired grayscale is displayed.

The first polarizing film 111 may be disposed under the first substrate 110. The first polarizing film 111 may have a light transmitting axis of a first direction so that the first polarizing film 111 polarizes a light in the first direction. The second polarizing film 121 may be disposed on the second substrate 120. The second polarizing film 121 may have a light transmitting axis of a second direction so that the second polarizing film 121 polarizes a light in the second direction. For example, the light transmitting axis of the first polarizing film 111 may be substantially perpendicular to the light transmitting axis of the second polarizing film 121.

The display panel 100 may further include a driving chip 130 to drive the first substrate 110. The driving chip 130 may generate a driving signal to drive the first substrate 110 in response to control signals received from outside. In an exemplary embodiment, the driving chip 130 may be disposed in a first end portion of the first substrate 110. For example, the driving chip 130 may be electrically connected to the first substrate 110 in a process of chip on glass (“COG”).

The main flexible printed circuit board 140 may be electrically connected to the first end portion of the first substrate 110. The main flexible printed circuit board 140 may apply the control signals to the display panel 100. For example, the main flexible printed circuit board 140 may be electrically connected to the first substrate 110 in a process of film on glass (“FOG”). The main flexible printed circuit board 140 may be connected to the first end portion of the first substrate 110 and may be bended toward a lower surface of the display panel 100. For example, the main flexible printed circuit board 140 may include a flexible resin material.

The backlight assembly 200 may be disposed under the display panel 100. The backlight assembly 200 may include a light source unit generating a light, a lower mold frame 250 receiving the light source unit and an upper mold frame 210 disposed on the lower mold frame 250 and covers outside walls of the lower mold frame 250.

The light source unit may include a light source flexible printed circuit board 221, a point light source 222, a light guide plate 230, and an optical sheet.

The light source flexible printed circuit board 221 may provide a driving power to the point light source 222 disposed on a first surface of the light source flexible printed circuit board 221. In the present exemplary embodiment, the light source flexible printed circuit board 221 may be disposed under the first end portion of the first substrate 110 corresponding to the main flexible printed circuit board 140. For example, metal wirings may be formed on the light source flexible printed circuit board 221. The light source flexible printed circuit board 221 may include a flexible resin material.

The point light source 222 may be disposed on the light source flexible printed circuit board 221, and generates a light. In the present exemplary embodiment, the point light source 222 may be mounted on the first surface of the light source flexible printed circuit board 221. For example, the point light source 222 may include a light emitting diode (“LED”) generating a white light. The number of the point light source 222 may vary according to a size of the display panel 100 and a desired luminance of the display panel 100. In the present exemplary embodiment, the light source flexible printed circuit board 221 and the point light source 222 may be disposed in a first side of the light guide plate 230.

The light guide plate 230 may be disposed under the display panel 100. The light guide plate 230 may have a flat shape. The light guide plate 230 may face a light exiting surface of the point light source 222. The light guide plate 230 may have a recess for receiving the point light source 222. The point light source 222 may be inserted into the recess so that a loss of the light may be reduced. The light guide plate 230 may guide the light from the point light source 222 toward the display panel 100.

The light guide plate 230 may include a transparent material to minimize the loss of the light. For example, the light guide plate 230 may include Polymethyl Methacrylate (PMMA) which has a high strength.

Alternatively, the light guide plate 230 may include Poly Carbonate (PC), which has a strength less than the Polymethyl Methacrylate but is more thermostable than the Polymethyl Methacrylate, to reduce a thickness of the light guide plate 230.

The optical sheet may improve characteristics of the light exited from the light guide plate 230. The optical sheet may include a reflective sheet 241, a diffusing sheet 242 and a prism sheet 243.

The reflective sheet 241 may be disposed under the light guide plate 230. The reflective sheet 241 reflects the light leaked under the light guide plate 230 again to the light guide plate 230 so that the efficiency of the light may increase.

The diffusing sheet 242 may be disposed on the light guide plate 230. The diffusing sheet 242 may diffuse the light exiting from the light guide plate 230.

The prism sheet 243 may be disposed on the diffusing sheet 242. The prism sheet 243 may condense the light exited from the diffusing sheet 242 to a front direction of the display panel 100. For example, the prism sheet 243 may include a vertical prism sheet condensing the light in a vertical direction and a horizontal prism sheet condensing the light in a horizontal direction.

The upper mold frame 210 may cover the outside of the light source unit so that it does not expose a bottom of the light source unit. The upper mold frame 210 may be combined with the display panel 100 which is disposed on the light source unit. The upper mold frame 210 may have a rectangular shape. The upper mold frame 210 may include a meltable resin material. For example, the upper mold frame 210 may include Polymethyl Methacrylate (PMMA) which has a high strength.

Alternatively, the upper mold frame 210 may include Poly Carbonate (PC), which has a strength less than the Polymethyl Methacrylate, but is more thermostable than the Polymethyl Methacrylate.

The upper mold frame 210 may include a supporting portion 211 and a transmitting portion 212. The supporting portion 211 may support the display panel 100. The transmitting portion 212 may transmit the light exited from the light guide plate 230 to the display panel 100. The supporting portion 211 may have a first color. The transmitting portion 212 may have a second color. For example, the supporting portion 211 may be black and the transmitting portion 212 may have a transparent color.

The supporting portion 211 and the transmitting portion 212 may be integrally formed. The upper mold frame 210 may be formed by an insert injection process. For example, the upper mold frame 210 having the black supporting portion 211 and the transparent transmitting portion 212 may be formed by a double injection process.

The lower mold frame 250 may receive the light source unit. The lower mold frame 250 may has a material substantially the same as the material of the upper mold frame 210.

The outside walls of the lower mold frame 250 may be covered by the upper mold frame 210.

The display panel 100 may be disposed on an upper surface of the upper mold frame 210. A lower surface of the display panel 100 may be attached to the upper surface of the upper mold frame 210 by an adhesive. For example, the lower surface of the display panel 100 may be attached to the upper surface of the upper mold frame 210 by an optically clear adhesive (“OCA”). The transmitting portion 212 of the upper mold frame 210 may be formed in a transparent color. Thus, the light exiting from the light guide plate 230 may be transmitted to the display panel 100 through the transmitting portion 212.

The upper surface of the display panel 100 may not be covered by any elements. Thus, the upper surface of the display panel 100 may be entirely exposed. According to the present exemplary embodiment, any elements partially covering the display panel such as a top chassis are omitted so that the upper surface of the display panel 100 may be entirely exposed.

The receiving container 300 may cover the backlight assembly 200 to which the display panel 100 is attached. The receiving container 300 may include a metal having a high strength and a little deformation. For example, the receiving container 300 may be a chassis including a metal.

The touch controller 400 may include a touch driver 405, a first connecting line 410, and a second connecting line 420.

The touch driver 405 may be electrically connected to the first connecting line 410 and the second connecting line 420.

The first connecting line 410 may electrically connect a metal pattern formed on the display panel 100 and the touch driver 405. The second connecting line 420 may electrically connect the receiving container 300 and the touch driver 405. The metal pattern formed on the display panel 100 may be spaced apart from the receiving container 300.

The touch driver 405 may sense change of capacitance due to change of distance between the metal pattern formed on the display panel 100 and the receiving container 300.

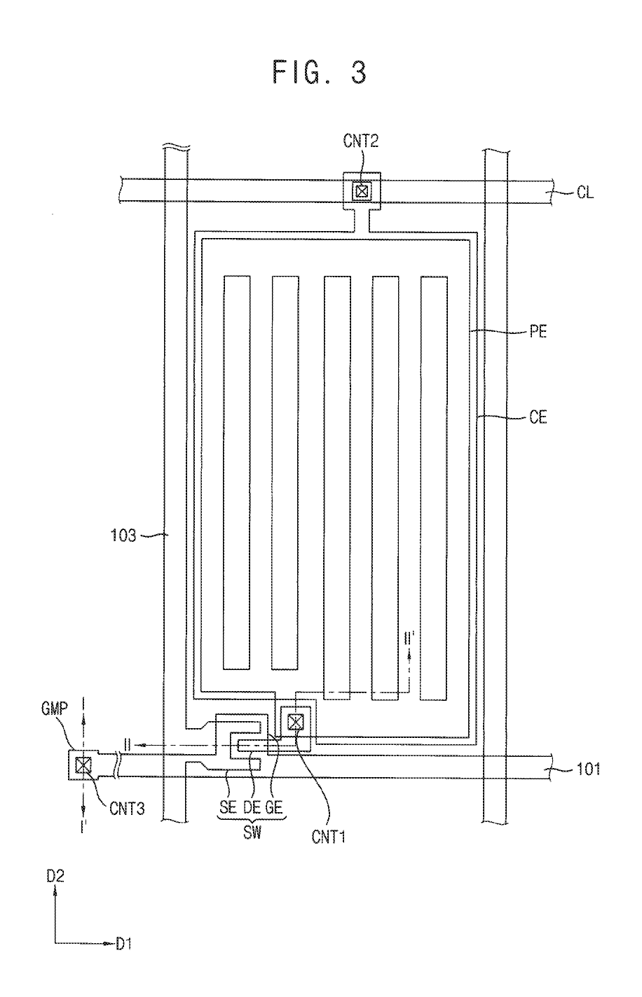

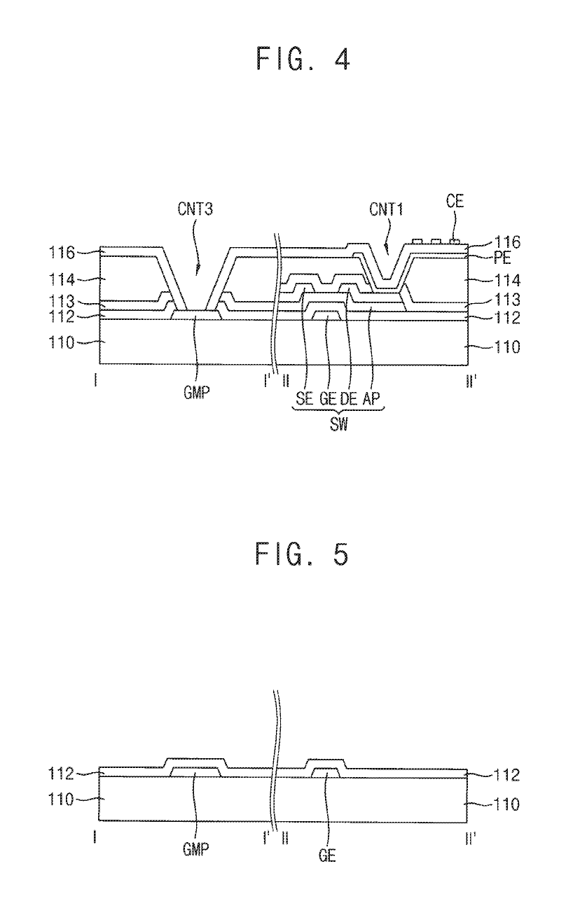

FIG. 3 is a plan view illustrating the display panel 100 of FIG. 1. FIG. 4 is a cross-sectional view illustrating the display panel 100 of FIG. 3 cut along a line I-I′ and a line II-II′ in FIG. 3.

Referring to FIGS. 3 and 4, the display panel 100 of the touch display apparatus includes a base substrate 110, a gate metal pattern disposed on the base substrate 110, a data metal pattern disposed on the gate metal pattern, the pixel electrode PE, the common electrode CE and a gate metal pad GMP electrically connected to the gate metal pattern.

The gate metal pattern may include a gate line 101 extending in a first direction D1, and a gate electrode GE electrically connected to the gate line 101.

The data metal pattern may include a data line 103 extending in a second direction D2 crossing the first direction D1, a source electrode SE electrically connected to the data line 103, and a drain electrode DE spaced apart from the source electrode SE.

The base substrate 110 may be one of a glass substrate, a quartz substrate, a silicon substrate, and a plastic substrate.

The gate electrode GE may be disposed on the base substrate 110. The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals. For example, the gate electrode GE may include a lower layer including titanium (Ti) and a upper layer disposed on the lower layer including copper (Cu).

A gate insulating layer 112 may be formed on the gate electrode GE. The gate insulating layer 112 may cover the base substrate 110 and a first conductive pattern including the gate electrode GE. The gate insulating layer 112 may include an inorganic insulating material. For example, the gate insulating layer 112 may include silicon oxide (SiO_{X}) or silicon nitride (SiN_{X}). For example, the gate insulating layer 112 may include silicon oxide (SiO_{X}) and has a thickness of 500 Å (angstrom). The gate insulating layer 112 may have a plurality of layers including different materials.

An active pattern AP may be formed on the gate insulating layer 112. The active pattern AP may be formed on the gate insulating layer 112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE.

The source electrode SE and the drain electrode DE may be formed on the active pattern AP. The source electrode SE and the drain electrode DE may be spaced apart from each other on the active pattern AP.

The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include a plurality of layers including different metals. For example, the source electrode SE and the drain electrode DE may include a copper (Cu) layer and a titanium (Ti) layer disposed on or under the copper (Cu) layer.

A first passivation layer 113 may be formed on the source electrode SE and the drain electrode DE. The first passivation layer 113 may include at least one of a silicon oxide (SiO_{X}) and a silicon nitride (SiN_{X}).

An organic layer 114 may be formed on the first passivation layer 113. The organic layer 114 may planarize an upper surface of the display panel 100 so that a problem due to an uneven upper surface such as a cut off of a signal wiring may be prevented. The organic layer 114 may be an insulation layer including an organic material.

The pixel electrode PE may be formed on the organic layer 114. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium. The pixel electrode PE may be electrically connected to the drain electrode DE through a first contact hole CNT1.

A second passivation layer 116 may be formed on the pixel electrode PE. The second passivation layer 116 may include at least one of a silicon oxide (SiO_{X}) and a silicon nitride (SiN_{X}).

The common electrode CE may be formed on the second passivation layer 116.

The common electrode CE may overlap the pixel electrode PE. The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium. The common electrode CE may be electrically connected to a common line CL through a second contact hole CNT2.

The gate metal pad GMP may be electrically connected to the gate metal pattern. The gate metal pad GMP may be electrically connected to the touch driver 405 through the first connecting line 410. The first connecting line 410 may be electrically connected to the main flexible printed circuit board 140. The main flexible printed circuit board 140 may be electrically connected to the gate metal pad GMP in a process of chip on glass (“COG”). However, the present disclosure is not limited thereto, the first connecting line 410 may be connected to the gate metal pad GMP in various methods.

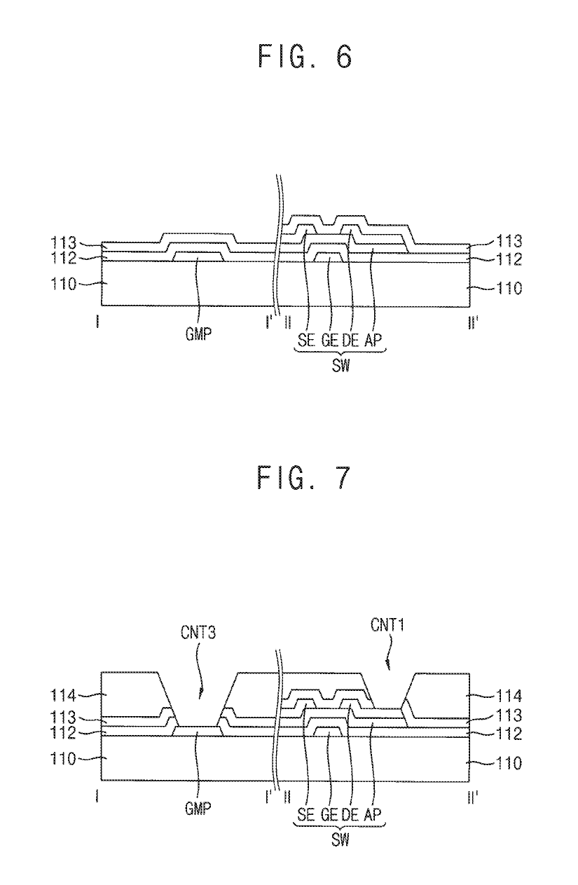

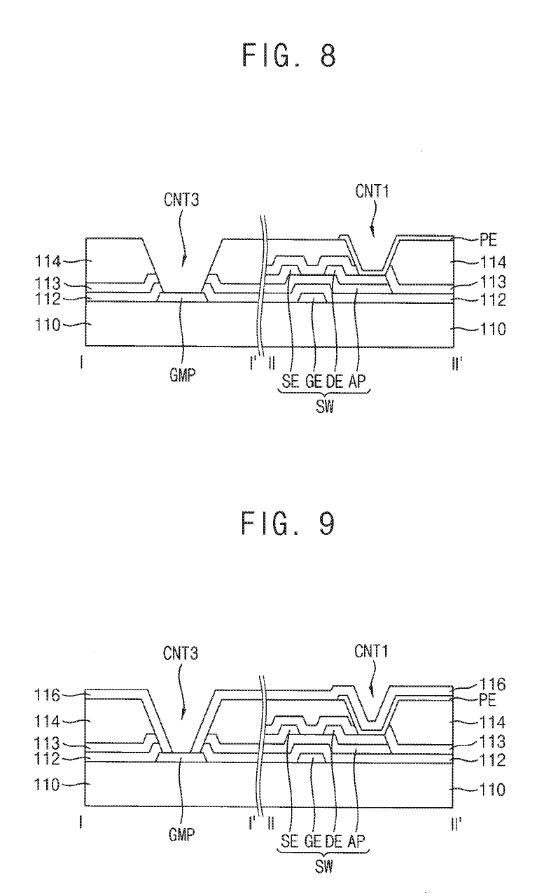

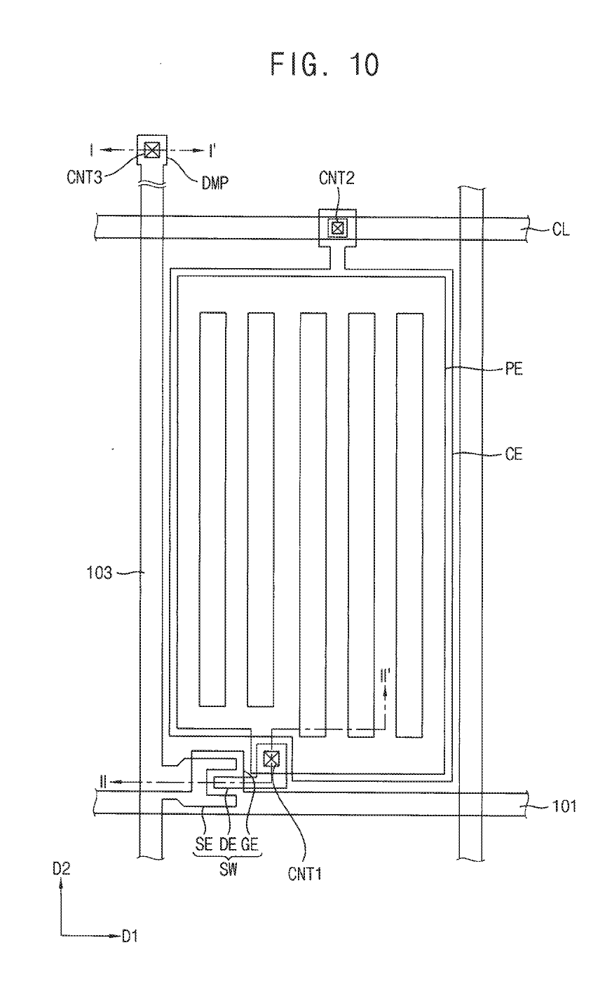

FIGS. 5 to 9 are cross-section views illustrating a method of manufacturing the display panel 100 of FIG. 3.

Referring to FIG. 5, the gate electrode GE, the gate metal pad GMP and the gate insulating layer 112 are formed on the base substrate 110.

The base substrate 110 may be one of a glass substrate, a quartz substrate, a silicon substrate and a plastic substrate.

The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals.

The gate metal pad GMP may include copper (Cu), silver (Ag), chromium (Cr), molybdenum (Mo), aluminum (Al), titanium (Ti), manganese (Mn), or an alloy thereof. The gate metal pad GMP may include a single layer. The gate metal pad GMP may include plural layers including different metals.

The gate insulating layer 112 may be formed on the base substrate 110 on which the gate electrode GE is formed. The gate insulating layer 112 may include silicon oxide (SiO_{X}) or silicon nitride (SiN_{X}).

Referring to FIG. 6, the active pattern AP, the source electrode SE, the drain electrode DE and the first passivation layer 113 may be formed on the base substrate 110 on which the gate insulating layer 112 is formed.

The active pattern AP may be formed on the gate insulating layer 112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE. The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

A first passivation layer 113 may include a material substantially the same as the material of the gate insulating layer 112. For example, the first passivation layer 113 may include at least one of a silicon oxide (SiO_{X}) and a silicon nitride (SiN_{X}).

Referring to FIG. 7, the organic layer 114 is formed on the base substrate 110 on which the first passivation layer 113 is formed. The organic layer 114 may planarize an upper surface of the display panel 100 so that a problem due to an uneven upper surface such as a cut off of a signal wiring may be prevented. The organic layer 114 and the first passivation layer 113 may be patterned to form the first contact hole CNT1 and a third contact hole CNT3.

The first contact hole CNT1 may expose a portion of the drain electrode DE. The third contact hole CNT3 may expose a portion of the gate metal pad GMP.

Referring to FIG. 8, the pixel electrode PE is formed on the base substrate 110 on which the first contact hole CNT1 and the third contact hole CNT3 are formed.

The pixel electrode PE may be electrically connected to the drain electrode DE through the first contact hole CNT1. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium.

Referring to FIG. 9, the second passivation layer 116 is formed on the base substrate 110 on which the pixel electrode PE is formed. The second passivation layer 116 may be patterned to generate the third contact hole CNT3 exposing the portion of the gate metal pad GMP.

The second passivation layer 116 may include a material substantially the same as the material of the first passivation layer 113. For example, the second passivation layer 116 may include at least one of a silicon oxide (SiO_{X}) and a silicon nitride (SiN_{X}).

The gate metal pad GMP may be electrically connected to the gate metal pattern. The gate metal pad GMP may be electrically connected to the touch driver 405 through the first connecting line 410. The first connecting line 410 may be electrically connected to the main flexible printed circuit board 140. The main flexible printed circuit board 140 may be electrically connected to the gate metal pad GMP in a process of chip on glass (“COG”). However, the present disclosure is not limited thereto, and the first connecting line 410 may be connected to the gate metal pad GMP in various methods.

Referring to FIG. 4, the common electrode CE is formed on the base substrate 110 on which the second passivation layer 116 is formed.

The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium.

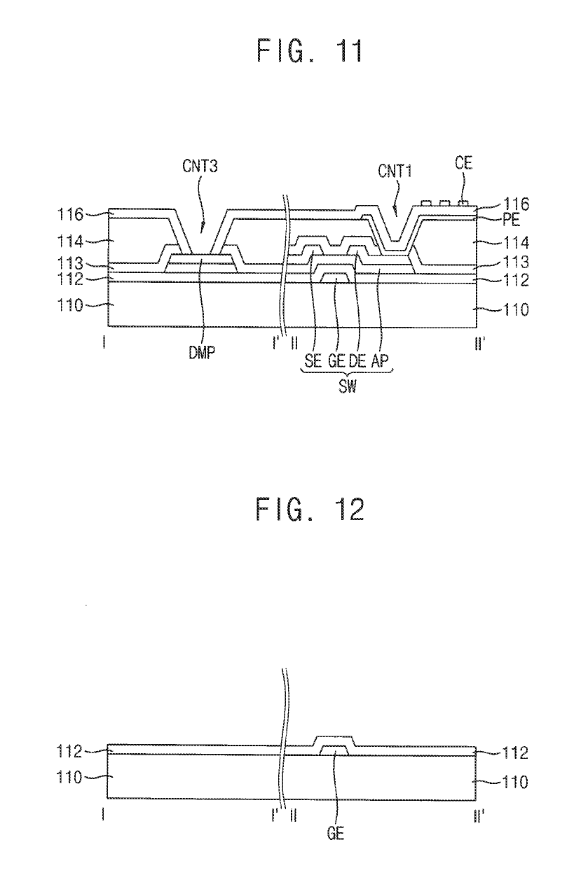

FIG. 10 is a plan view illustrating the display panel 100 of FIG. 1. FIG. 11 is a cross-sectional view illustrating the display panel 100 of FIG. 10 cut along a line I-I′ and a line II-II′ in FIG. 10.

Referring to FIGS. 10 and 11, the display panel 100 of the touch display apparatus includes a base substrate 110, a gate metal pattern disposed on the base substrate 110, a data metal pattern disposed on the gate metal pattern, the pixel electrode PE, the common electrode CE and a data metal pad DMP electrically connected to the data metal pattern.

The gate metal pattern may include the gate line 101 extending in the first direction D1 and the gate electrode GE electrically connected to the gate line 101.

The data metal pattern may include a data line 103 extending in a second direction D2 crossing the first direction D1, the source electrode SE electrically connected to the data line 103, and the drain electrode DE spaced apart from the source electrode SE.

The base substrate 110 may be one of a glass substrate, a quartz substrate, a silicon substrate and a plastic substrate.

The gate electrode GE may be disposed on the base substrate 110. The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals. For example, the gate electrode GE may include a lower layer including titanium (Ti) and a upper layer disposed on the lower layer and including copper (Cu).

A gate insulating layer 112 may be formed on the gate electrode GE. The gate insulating layer 112 may cover the base substrate 110 and a first conductive pattern including the gate electrode GE. The gate insulating layer 112 may include an inorganic insulating material. For example, the gate insulating layer 112 may include silicon oxide (SiO_{X}) or silicon nitride (SiN_{X}). For example, the gate insulating layer 112 includes silicon oxide (SiO_{X}) and has a thickness of 500 Å. The gate insulating layer 112 may have a plurality of layers including different materials.

An active pattern AP may be formed on the gate insulating layer 112. The active pattern AP may be formed on the gate insulating layer 112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE.

The source electrode SE and the drain electrode DE may be formed on the active pattern AP. The source electrode SE and the drain electrode DE may be spaced apart from each other on the active pattern AP.

The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

A first passivation layer 113 may be formed on the source electrode SE and the drain electrode DE. The first passivation layer 113 may include at least one of a silicon oxide (SiO_{X}) and a silicon nitride (SiN_{X}).

An organic layer 114 may be formed on the first passivation layer 113. The organic layer 114 may planarize an upper surface of the display panel 100 so that a problem due to an uneven upper surface such as a cut off of a signal wiring may be prevented. The organic layer 114 may be an insulation layer including an organic material.

The pixel electrode PE may be formed on the organic layer 114. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium. The pixel electrode PE may be electrically connected to the drain electrode DE through a first contact hole CNT1.

A second passivation layer 116 may be formed on the pixel electrode PE. The second passivation layer 116 may include at least one of a silicon oxide (SiO_{X}) and a silicon nitride (SiN_{X}).

The common electrode CE may be formed on the second passivation layer 116. The common electrode CE overlaps the pixel electrode PE. The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium. The common electrode CE may be electrically connected to a common line CL through a second contact hole CNT2.

The data metal pad DMP may be electrically connected to the data metal pattern. The data metal pad DMP may be electrically connected to the touch driver 405 through the first connecting line 410. The first connecting line 410 may be electrically connected to the main flexible printed circuit board 140. The main flexible printed circuit board 140 may be electrically connected to the data metal pad DMP in a process of chip on glass (“COG”). However, the present disclosure is not limited thereto, and the first connecting line 410 may be connected to the data metal pad DMP in various methods.

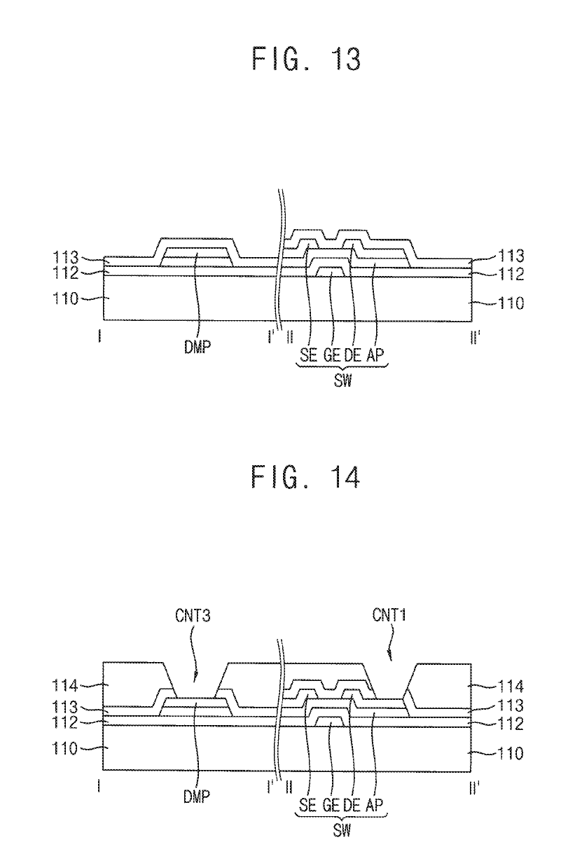

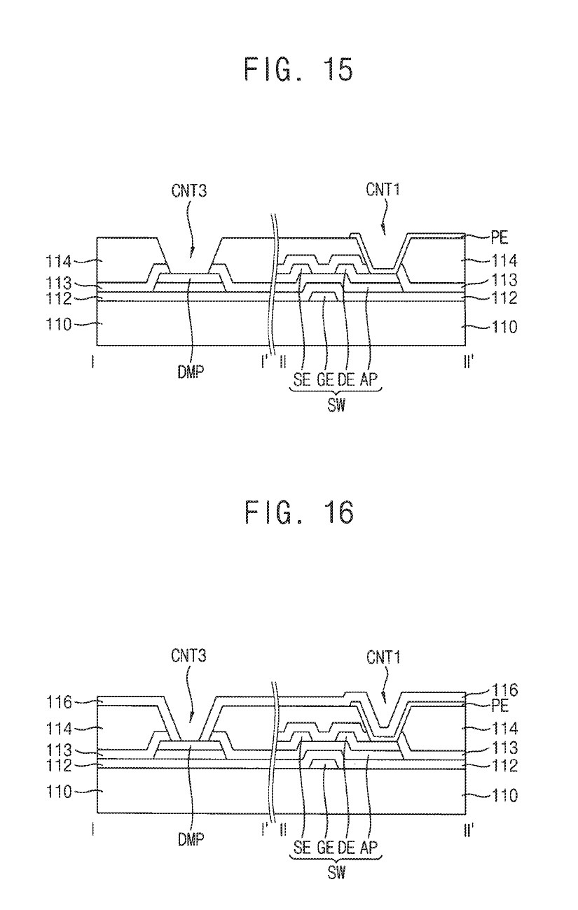

FIGS. 12 to 16 are cross-section views illustrating a method of manufacturing the display panel 100 of FIG. 11.

Referring to FIG. 12, the gate electrode GE and the gate insulating layer 112 are formed on the base substrate 110.

The base substrate 110 may be one of a glass substrate, a quartz substrate, a silicon substrate and a plastic substrate.

The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals.

The gate insulating layer 112 may be formed on the base substrate 110 on which the gate electrode GE is formed. The gate insulating layer 112 may include silicon oxide (SiO_{X}) or silicon nitride (SiN_{X}).

Referring to FIG. 13, the active pattern AP, the source electrode SE, the drain electrode DE and the first passivation layer 113 are formed on the base substrate 110 on which the gate insulating layer 112 is formed.

The active pattern AP may be formed on the gate insulating layer 112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE. The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

The data metal pad DMP may include copper (Cu), silver (Ag), chromium (Cr), molybdenum (Mo), aluminum (Al), titanium (Ti), manganese (Mn), or an alloy thereof. The data metal pad DMP may include a single layer. The data metal pad DMP may include plural layers including different metals. For example, the data metal pad DMP may include a copper (Cu) layer and a titanium (Ti) layer disposed on or under the copper (Cu) layer.

The first passivation layer 113 may include a material substantially the same as the material of the gate insulating layer 112. For example, the first passivation layer 113 may include at least one of a silicon oxide (SiO_{X}) and a silicon nitride (SiN_{X}).

Referring to FIG. 14, the organic layer 114 may be formed on the base substrate 110 on which the first passivation layer 113 is formed. The organic layer 114 may planarize an upper surface of the display panel 100 so that a problem due to an uneven upper surface such as a cut off of a signal wiring may be prevented. The organic layer 114 and the first passivation layer 113 may be patterned to form the first contact hole CNT1 and a third contact hole CNT3.

The first contact hole CNT1 may expose a portion of the drain electrode DE. The third contact hole CNT3 may expose a portion of the data metal pad DMP.

Referring to FIG. 15, the pixel electrode PE may be formed on the base substrate 110 on which the first contact hole CNT1 and the third contact hole CNT3 are formed.

The pixel electrode PE may be electrically connected to the drain electrode DE through the first contact hole CNT1. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium.

Referring to FIG. 16, the second passivation layer 116 may be formed on the base substrate 110 on which the pixel electrode PE is formed. The second passivation layer 116 may be patterned to generate the third contact hole CNT3 exposing the portion of the data metal pad DMP.

The second passivation layer 116 may include a material substantially the same as the material of the first passivation layer 113. For example, the second passivation layer 116 may include at least one of a silicon oxide (SiO_{X}) and a silicon nitride (SiN_{X}).

The data metal pad DMP may be electrically connected to the data metal pattern. The data metal pad DMP may be electrically connected to the touch driver 405 through the first connecting line 410. The first connecting line 410 may be electrically connected to the main flexible printed circuit board 140. The main flexible printed circuit board 140 may be electrically connected to the data metal pad DMP in a process of chip on glass (“COG”). However, the present disclosure is not limited thereto, and the first connecting line 410 may be connected to the data metal pad DMP in various methods.

Referring to FIG. 11, the common electrode CE is formed on the base substrate 110 on which the second passivation layer 116 is formed.

The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium.

According to the present exemplary embodiment, the first connecting line 410 of the touch controller 400 may electrically connect the gate metal pattern or the data metal pattern formed on the display panel 100 to the touch driver 405. In addition, the second connecting line 420 may electrically connect the receiving container 300 to the touch driver 405. The metal pattern formed on the display panel 100 may be spaced apart from the receiving container 300 in a predetermined distance. Accordingly, the touch driver 405 may sense the change of the capacitance due to the change of the distance between the receiving container 300 and the gate metal pattern or the data metal pattern formed on the display panel 100.

Therefore, the thickness of the touch display apparatus may decrease and the manufacturing cost of the touch display apparatus may be reduced.

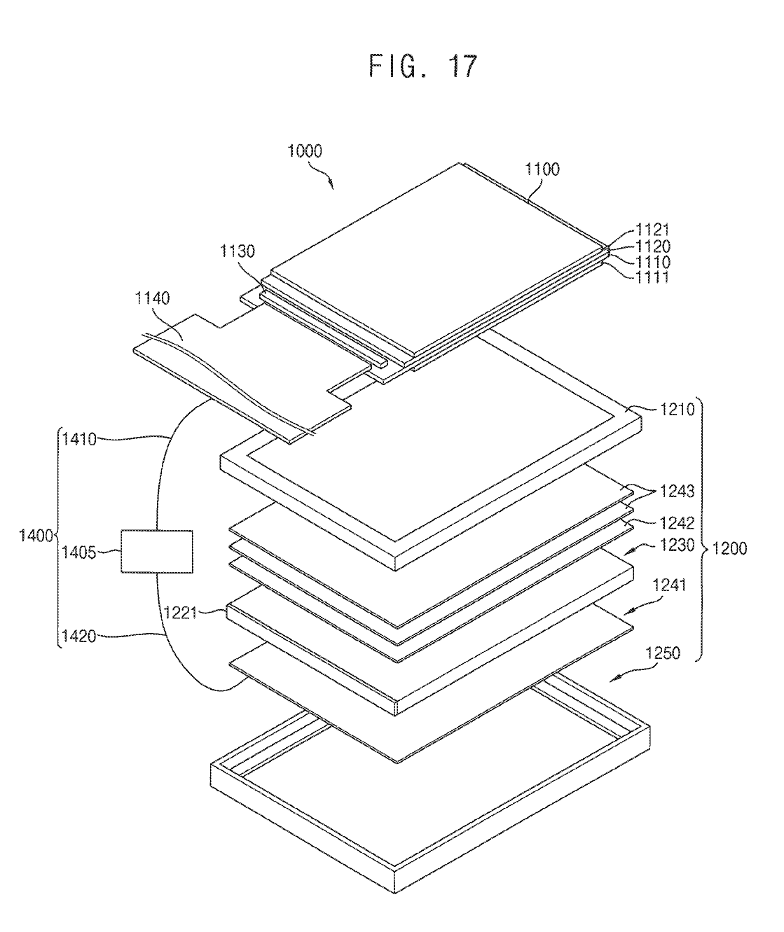

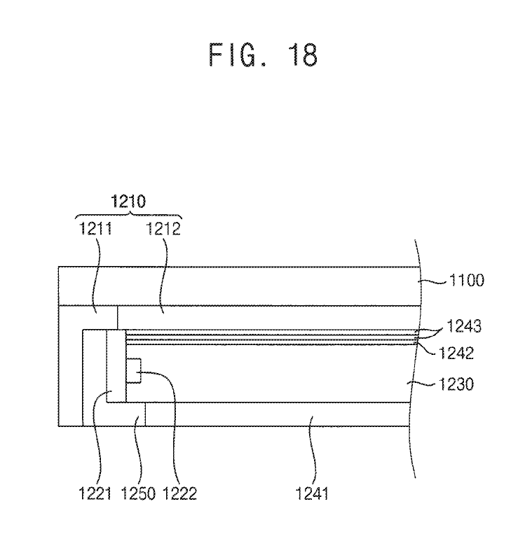

FIG. 17 is an exploded perspective view illustrating a touch display apparatus 2000 according to an exemplary embodiment of the present disclosure. FIG. 18 is a cross-sectional view illustrating the touch display apparatus 2000 of FIG. 17;

Referring to FIGS. 17 and 18, the display apparatus 1000 may include a display panel 1100, a main flexible printed circuit board 1140 electrically connected to the display panel 1100, a backlight assembly 1200 providing light to the display panel 1100, and a touch controller 1400.

The display panel 1100 includes a first substrate 1110, a second substrate 1120 opposite to the first substrate 1110, a liquid crystal layer (not shown) disposed between the first substrate 1110 and the second substrate 1120, a first polarizing film 1111 disposed under the first substrate 1110 and a second polarizing film 1121 disposed on the second substrate 1120. The display panel 1100 may display an image using the light from the backlight assembly 1200.

Thin film transistors (“TFT”s) which are switching elements may be formed in a matrix form on the first substrate 1110. Source electrodes of the TFTs may be respectively connected to gate lines. Gate electrodes of the TFTs may be respectively connected to data lines. Drain electrodes of the TFTs may be respectively connected to pixel electrodes which include a transparent and conductive material.

The second substrate 1120 may be opposite to the first substrate 1110. RGB color filters to represent RGB colors are formed on the second substrate 1120. A common electrode including a transparent and conductive material is formed on the second substrate 1120. The common electrode may face the pixel electrodes of the first substrate 1110.

When a signal is applied to the gate electrode of the TFT in the display panel 1100, the TFT may be turned on. When the TFT is turned on, an electric field may be formed between the pixel electrode and the common electrode. Arrangement of liquid crystal molecules of the liquid crystal layer disposed between the first substrate 1110 and the second substrate 1120 may be changed by the electric field. According to the change of the arrangement of the liquid crystal molecules, light transmittance of the liquid crystal layer may be changed so that an image of a desired grayscale is displayed.

The first polarizing film 1111 may be disposed under the first substrate 1110. The first polarizing film 1111 may have a light transmitting axis of a first direction so that the first polarizing film 1111 polarizes a light in the first direction. The second polarizing film 1121 may be disposed on the second substrate 1120. The second polarizing film 1121 may have a light transmitting axis of a second direction so that the second polarizing film 1121 polarizes a light in the second direction. For example, the light transmitting axis of the first polarizing film 1111 may be substantially perpendicular to the light transmitting axis of the second polarizing film 1121.

The display panel 1100 may further include a driving chip 1130 to drive the first substrate 1110. The driving chip 1130 may generate a driving signal to drive the first substrate 1110 in response to control signals received from outside. In an exemplary embodiment, the driving chip 1130 may be disposed in a first end portion of the first substrate 1110. For example, the driving chip 1130 may be electrically connected to the first substrate 1110 in a process of chip on glass (“COG”).

The main flexible printed circuit board 1140 may be electrically connected to the first end portion of the first substrate 1110. The main flexible printed circuit board 1140 may apply the control signals to the display panel 1100. For example, the main flexible printed circuit board 1140 may be electrically connected to the first substrate 1110 in a process of film on glass (“FOG”). The main flexible printed circuit board 1140 may be connected to the first end portion of the first substrate 1110 and may be bended toward a lower surface of the display panel 1100. For example, the main flexible printed circuit board 1140 may include a flexible resin material.

The backlight assembly 1200 may be disposed under the display panel 1100. The backlight assembly 1200 may include a light source unit generating a light, a lower mold frame 1250 receiving the light source unit, and an upper mold frame 1210 disposed on the lower mold frame 1250 and covers outside walls of the lower mold frame 1250.

The light source unit may include a light source flexible printed circuit board 1221, a point light source 1222, a light guide plate 1230, and an optical sheet.

The light source flexible printed circuit board 1221 may provide a driving power to the point light source 1222 disposed on a first surface of the light source flexible printed circuit board 1221. In the present exemplary embodiment, the light source flexible printed circuit board 1221 may be disposed under the first end portion of the first substrate 1110 corresponding to the main flexible printed circuit board 1140. For example, metal wirings may be formed on the light source flexible printed circuit board 1221. The light source flexible printed circuit board 1221 may include a flexible resin material.

The point light source 1222 may be disposed on the light source flexible printed circuit board 1221 and generate a light. In the present exemplary embodiment, the point light source 1222 may be mounted on the first surface of the light source flexible printed circuit board 1221. For example, the point light source 1222 may include a light emitting diode (“LED”) generating a white light. The number of the point light source 1222 may vary according to a size of the display panel 1100 and a desired luminance of the display panel 1100. In the present exemplary embodiment, the light source flexible printed circuit board 1221 and the point light source 1222 may be disposed in a first side of the light guide plate 1230.

The light guide plate 1230 may be disposed under the display panel 1100. The light guide plate 1230 may have a flat shape. The light guide plate 1230 may face a light exiting surface of the point light source 1222. The light guide plate 1230 may have a recess for receiving the point light source 1222. The point light source 1222 is inserted into the recess so that a loss of the light may be reduced. The light guide plate 1230 guides the light from the point light source 1222 toward the display panel 1100.

The light guide plate 1230 may include a transparent material to minimize the loss of the light. For example, the light guide plate 1230 may include Polymethyl Methacrylate (PMMA) which has a high strength.

Alternatively, the light guide plate 1230 may include Poly Carbonate (PC), which has a strength less than the Polymethyl Methacrylate but which is more thermostable than the Polymethyl Methacrylate, in order to reduce a thickness of the light guide plate 1230.

The optical sheet may improve characteristics of the light exited from the light guide plate 1230. The optical sheet may include a reflective sheet 1241, a diffusing sheet 1242 and a prism sheet 1243.

The reflective sheet 1241 may be disposed under the light guide plate 1230. The reflective sheet 1241 may reflect light leaked under the light guide plate 1230 to the light guide plate 1230 so that the efficiency of the light may increase.

In the present exemplary embodiment, the reflective sheet 1241 may include a metal. The reflective sheet 1241 may be electrically connected to a second connecting line 1420 of the touch controller 1400.

The diffusing sheet 1242 may be disposed on the light guide plate 1230. The diffusing sheet 1242 may diffuse the light exited from the light guide plate 1230.

The prism sheet 1243 may be disposed on the diffusing sheet 1242. The prism sheet 1243 may condense the light exiting from the diffusing sheet 1242 to a front direction of the display panel 1100. For example, the prism sheet 1243 may include a vertical prism sheet condensing the light in a vertical direction and a horizontal prism sheet condensing the light in a horizontal direction.

The upper mold frame 1210 may cover the outside of the light source unit in order to not expose a bottom of the light source unit. The upper mold frame 1210 may be combined with the display panel 1100 which is disposed on the light source unit. The upper mold frame 1210 may have a rectangular shape. The upper mold frame 1210 may include a meltable resin material. For example, the upper mold frame 1210 may include Polymethyl Methacrylate (PMMA) which has a high strength.

Alternatively, the upper mold frame 1210 may include Poly Carbonate (PC), which has a strength less than the Polymethyl Methacrylate but which is more thermostable than the Polymethyl Methacrylate.

The upper mold frame 1210 may include a supporting portion 1211 and a transmitting portion 1212. The supporting portion 1211 may support the display panel 1100. The transmitting portion 1212 may transmit light exiting from the light guide plate 1230 to the display panel 1100. The supporting portion 1211 may have a first color. The transmitting portion 1212 may have a second color. For example, the supporting portion 1211 may be black and the transmitting portion 1212 may have a transparent color.

The supporting portion 1211 and the transmitting portion 1212 may be integrally formed. The upper mold frame 1210 may be formed by an insert injection process. For example, the upper mold frame 1210 having the black supporting portion 1211 and the transparent transmitting portion 1212 may be formed by a double injection process.

The lower mold frame 1250 may receive the light source unit. The lower mold frame 1250 may has a material substantially the same as the material of the upper mold frame 1210.

The outside walls of the lower mold frame 1250 may be covered by the upper mold frame 1210.

The display panel 1100 may be disposed on an upper surface of the upper mold frame 1210. A lower surface of the display panel 1100 may be attached to the upper surface of the upper mold frame 1210 by an adhesive. For example, the lower surface of the display panel 1100 may be attached to the upper surface of the upper mold frame 1210 by an optically clear adhesive (“OCA”). The transmitting portion 1212 of the upper mold frame 1210 may be formed in a transparent color. Thus, the light exited from the light guide plate 1230 is transmitted to the display panel 1100 through the transmitting portion 1212.

The upper surface of the display panel 1100 may not be covered by any elements. Thus, the upper surface of the display panel 1100 may be entirely exposed. According to the present exemplary embodiment, any elements partially covering the display panel such as a top chassis may be omitted so that the upper surface of the display panel 1100 may be entirely exposed.

The touch controller 1400 may include a touch driver 1405, a first connecting line 1410 and the second connecting line 1420.

The touch driver 1405 may be electrically connected to the first connecting line 1410 and the second connecting line 1420.

The first connecting line 1410 may electrically connect a metal pattern formed on the display panel 1100 and the touch driver 1405. The second connecting line 1420 may electrically connect the reflective sheet 1241 and the touch driver 1405. The metal pattern formed on the display panel 1100 may be spaced apart from the reflective sheet 1241.

The touch driver 1405 may sense change of capacitance due to change of distance between the metal pattern formed on the display panel 1100 and the reflective sheet 1241.

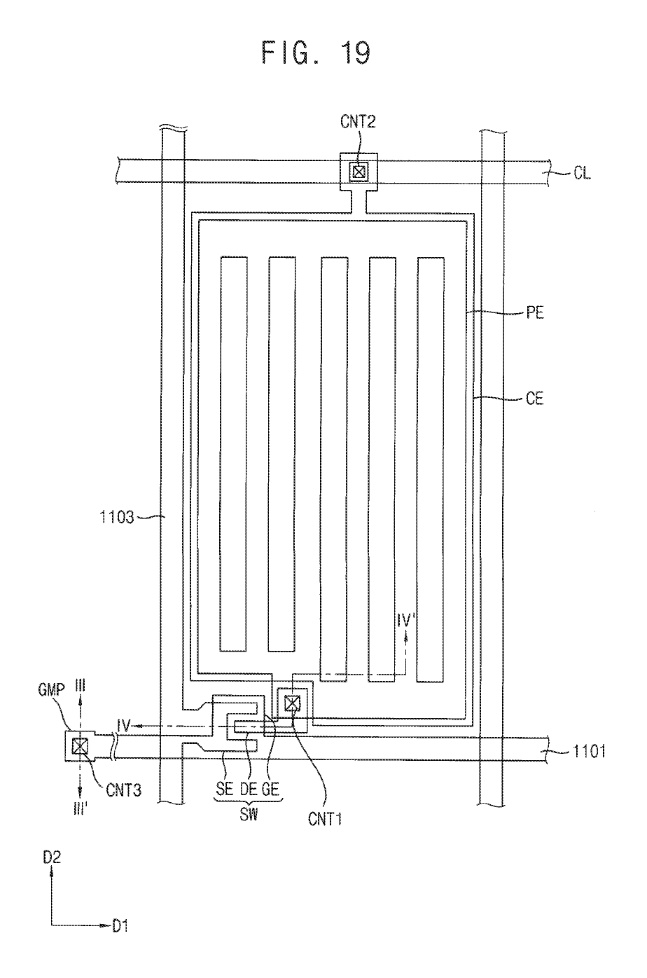

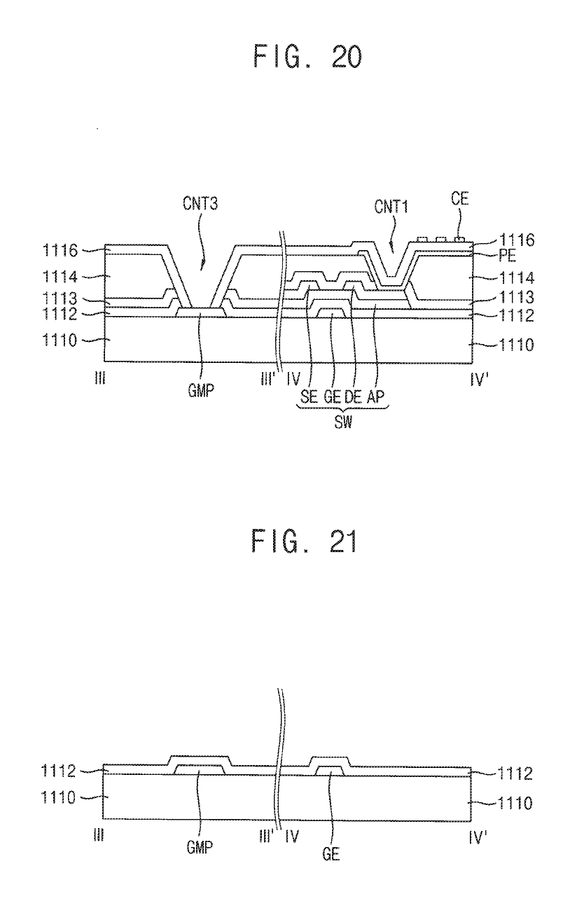

FIG. 19 is a plan view illustrating a display panel of FIG. 17. FIG. 20 is a cross-sectional view illustrating the display panel of FIG. 19 cut along a line III-III′ and a line IV-IV′ in FIG. 19.

Referring to FIGS. 19 and 20, the display panel 1100 of the touch display apparatus includes a base substrate 1110, a gate metal pattern disposed on the base substrate 1110, a data metal pattern disposed on the gate metal pattern, the pixel electrode PE, the common electrode CE, and a gate metal pad GMP electrically connected to the gate metal pattern.

The gate metal pattern may include a gate line 1101 extending in a first direction D1 and a gate electrode GE electrically connected to the gate line 1101.

The data metal pattern may include a data line 1103 extending in a second direction D2 crossing the first direction D1, a source electrode SE electrically connected to the data line 1103, and a drain electrode DE spaced apart from the source electrode SE.

The base substrate 1110 may be one of a glass substrate, a quartz substrate, a silicon substrate, and a plastic substrate.

The gate electrode GE is disposed on the base substrate 1110. The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals. For example, the gate electrode GE may include a lower layer including titanium (Ti) and a upper layer disposed on the lower layer and including copper (Cu).

A gate insulating layer 1112 may be formed on the gate electrode GE. The gate insulating layer 1112 may cover the base substrate 1110 and a first conductive pattern including the gate electrode GE. The gate insulating layer 1112 may include an inorganic insulating material. For example, the gate insulating layer 1112 may include silicon oxide (SiO_{X}) or silicon nitride (SiN_{X}). For example, the gate insulating layer 1112 includes silicon oxide (SiO_{X}) and has a thickness of 500 Å. The gate insulating layer 1112 may has plural layers including different materials.

An active pattern AP may be formed on the gate insulating layer 1112. The active pattern AP may be formed on the gate insulating layer 1112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE.

The source electrode SE and the drain electrode DE may be formed on the active pattern AP. The source electrode SE and the drain electrode DE may be spaced apart from each other on the active pattern AP.

The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

A first passivation layer 1113 may be formed on the source electrode SE and the drain electrode DE. The first passivation layer 1113 may include at least one of a silicon oxide (SiO_{X}) and a silicon nitride (SiN_{X}).

An organic layer 1114 may be formed on the first passivation layer 1113. The organic layer 1114 may planarize an upper surface of the display panel 1100 so that a problem due to an uneven upper surface such as a cut off of a signal wiring may be prevented. The organic layer 1114 may be an insulation layer including an organic material.

The pixel electrode PE may be formed on the organic layer 1114. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium. The pixel electrode PE may be electrically connected to the drain electrode DE through a first contact hole CNT1.

A second passivation layer 1116 may be formed on the pixel electrode PE. The second passivation layer 1116 may include at least one of a silicon oxide (SiO_{X}) and a silicon nitride (SiN_{X}).

The common electrode CE may be formed on the second passivation layer 1116. The common electrode CE overlaps the pixel electrode PE. The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium. The common electrode CE may be electrically connected to a common line CL through a second contact hole CNT2.

The gate metal pad GMP may be electrically connected to the gate metal pattern. The gate metal pad GMP may be electrically connected to the touch driver 1405 through the first connecting line 1410. The first connecting line 1410 may be electrically connected to the main flexible printed circuit board 1140. The main flexible printed circuit board 1140 may be electrically connected to the gate metal pad GMP in a process of chip on glass (“COG”). However, the present disclosure is not limited thereto, and the first connecting line 410 may be connected to the gate metal pad GMP in various methods.

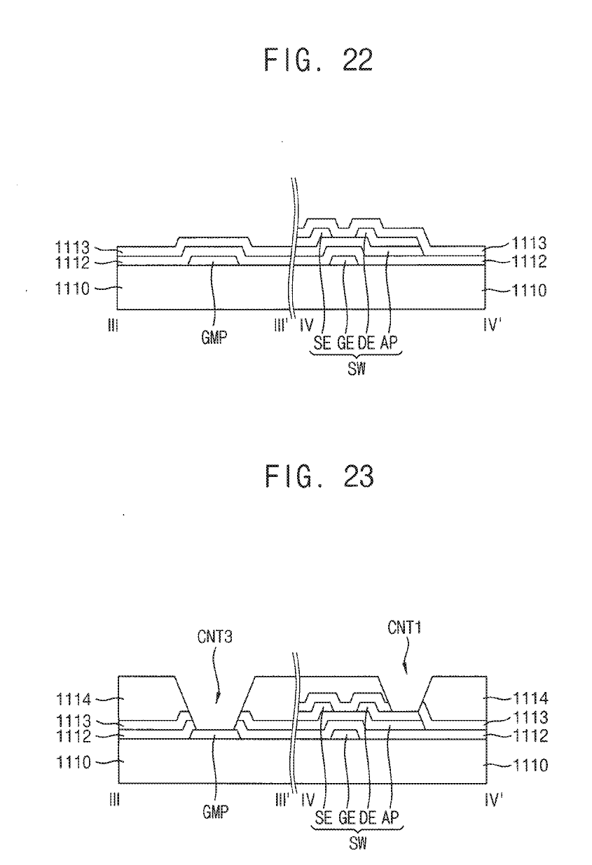

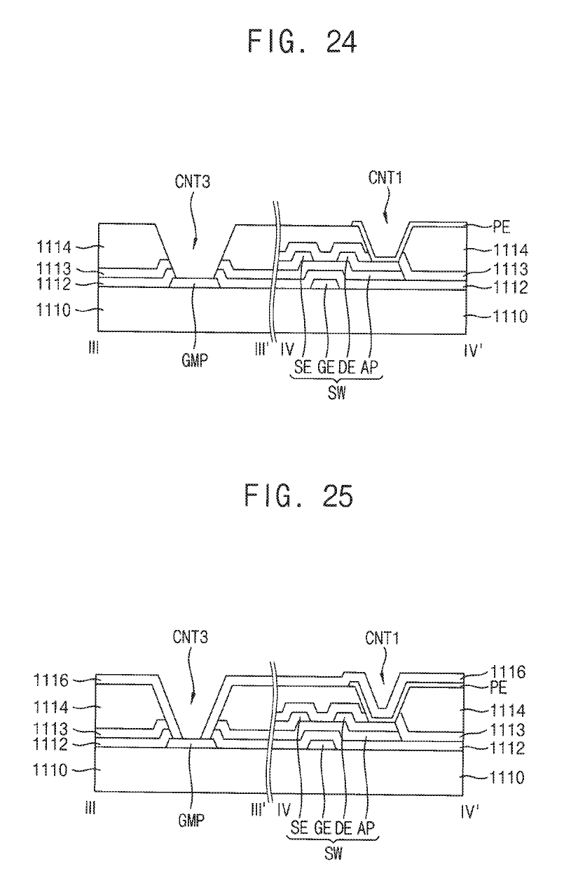

FIGS. 21 to 25 are cross-section views illustrating a method of manufacturing the display panel of FIG. 19.

Referring to FIG. 21, the gate electrode GE, the gate metal pad GMP and the gate insulating layer 1112 are formed on the base substrate 1110.

The base substrate 1110 may be one of a glass substrate, a quartz substrate, a silicon substrate, and a plastic substrate.

The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals.

The gate metal pad GMP may include copper (Cu), silver (Ag), chromium (Cr), molybdenum (Mo), aluminum (Al), titanium (Ti), manganese (Mn), or an alloy thereof. The gate metal pad GMP may include a single layer. The gate metal pad GMP may include plural layers including different metals.

The gate insulating layer 1112 may be formed on the base substrate 1110 on which the gate electrode GE is formed. The gate insulating layer 1112 may include silicon oxide (SiO_{X}) or silicon nitride (SiN_{X}).

Referring to FIG. 22, the active pattern AP, the source electrode SE, the drain electrode DE, and the first passivation layer 1113 are formed on the base substrate 1110 on which the gate insulating layer 1112 is formed.

The active pattern AP may be formed on the gate insulating layer 1112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE. The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

A first passivation layer 1113 may include a material substantially the same as the material of the gate insulating layer 1112. For example, the first passivation layer 1113 may include at least one of a silicon oxide (SiO_{X}) and a silicon nitride (SiN_{X}).

Referring to FIG. 23, the organic layer 1114 is formed on the base substrate 1110 on which the first passivation layer 1113 is formed. The organic layer 1114 may planarize an upper surface of the display panel 1100 so that a problem due to an uneven upper surface such as a cut off of a signal wiring may be prevented. The organic layer 1114 and the first passivation layer 1113 may be patterned to form the first contact hole CNT1 and a third contact hole CNT3.

The first contact hole CNT1 may expose a portion of the drain electrode DE. The third contact hole CNT3 may expose a portion of the gate metal pad GMP.

Referring to FIG. 24, the pixel electrode PE is formed on the base substrate 1110 on which the first contact hole CNT1 and the third contact hole CNT3 are formed.

The pixel electrode PE may be electrically connected to the drain electrode DE through the first contact hole CNT1. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium.

Referring to FIG. 25, the second passivation layer 1116 may be formed on the base substrate 1110 on which the pixel electrode PE is formed. The second passivation layer 1116 may be patterned to generate the third contact hole CNT3 exposing the portion of the gate metal pad GMP.

The second passivation layer 1116 may include a material substantially the same as the material of the first passivation layer 1113. For example, the second passivation layer 1116 may include at least one of a silicon oxide (SiO_{X}) and a silicon nitride (SiN_{X}).

The gate metal pad GMP may be electrically connected to the gate metal pattern. The gate metal pad GMP may be electrically connected to the touch driver 1405 through the first connecting line 1410. The first connecting line 1410 may be electrically connected to the main flexible printed circuit board 1140. The main flexible printed circuit board 1140 may be electrically connected to the gate metal pad GMP in a process of chip on glass (“COG”). However, the present disclosure is not limited thereto, and the first connecting line 1410 may be connected to the gate metal pad GMP in various methods.

Referring to FIG. 20, the common electrode CE is formed on the base substrate 1110 on which the second passivation layer 1116 is formed.

The common electrode CE may include a transparent and conductive material.

For example, the common electrode CE may include indium tin oxide (ITO) or indium zinc oxide (IZO). Alternatively, the common electrode CE may include titanium (Ti) or an alloy (MoTi) of molybdenum and titanium.

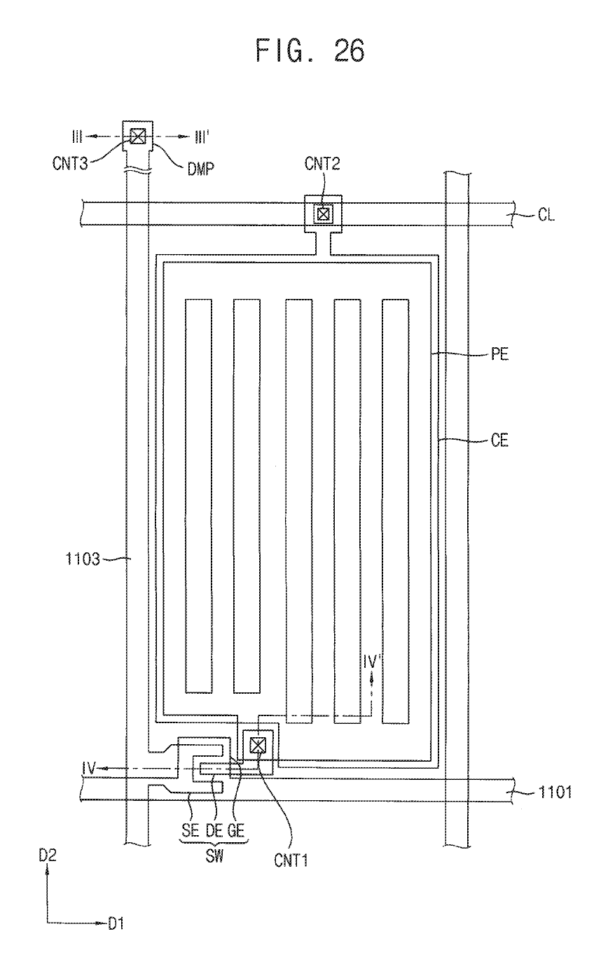

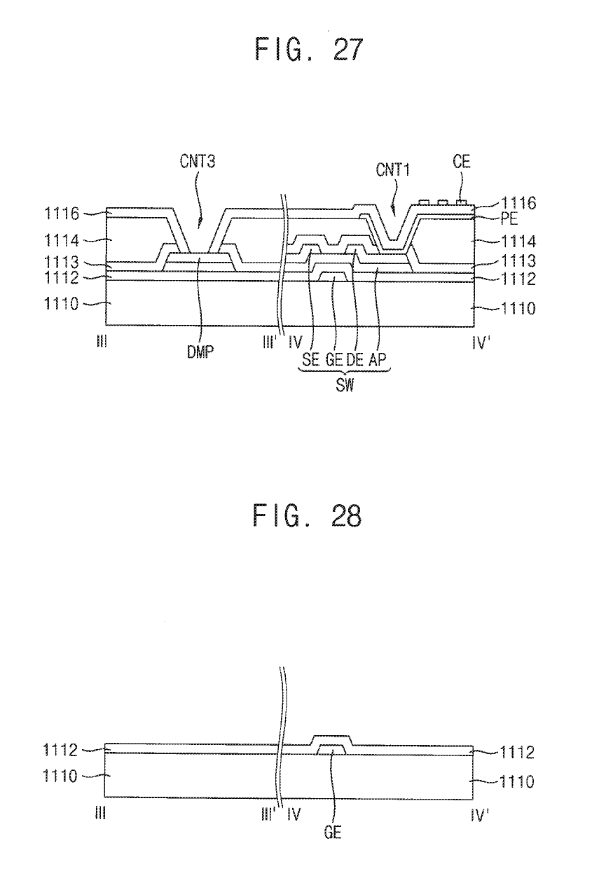

FIG. 26 is a plan view illustrating the display panel of FIG. 17. FIG. 27 is a cross-sectional view illustrating the display panel of FIG. 26 cut along a line III-III′ and a line IV-IV′ in FIG. 26.

Referring to FIGS. 26 and 27, the display panel 1100 of the touch display apparatus includes a base substrate 1110, a gate metal pattern disposed on the base substrate 1110, a data metal pattern disposed on the gate metal pattern, the pixel electrode PE, the common electrode CE and a data metal pad DMP electrically connected to the data metal pattern.

The gate metal pattern may include the gate line 1101 extending in the first direction D1 and the gate electrode GE electrically connected to the gate line 1101.

The data metal pattern may include a data line 1103 extending in a second direction D2 crossing the first direction D1, the source electrode SE electrically connected to the data line 1103 and the drain electrode DE spaced apart from the source electrode SE.

The base substrate 1110 may be one of a glass substrate, a quartz substrate, a silicon substrate and a plastic substrate.

The gate electrode GE is disposed on the base substrate 1110. The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals. For example, the gate electrode GE may include a lower layer including titanium (Ti) and a upper layer disposed on the lower layer and including copper (Cu).

A gate insulating layer 1112 may be formed on the gate electrode GE. The gate insulating layer 1112 may cover the base substrate 1110 and a first conductive pattern including the gate electrode GE. The gate insulating layer 1112 may include an inorganic insulating material. For example, the gate insulating layer 1112 may include silicon oxide (SiO_{X}) or silicon nitride (SiN_{X}). For example, the gate insulating layer 1112 includes silicon oxide (SiO_{X}) and has a thickness of 500 Å. The gate insulating layer 1112 may have a plurality of layers including different materials.

An active pattern AP may be formed on the gate insulating layer 1112. The active pattern AP may be formed on the gate insulating layer 1112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE.

The source electrode SE and the drain electrode DE may be formed on the active pattern AP. The source electrode SE and the drain electrode DE may be spaced apart from each other on the active pattern AP.

The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

A first passivation layer 1113 may be formed on the source electrode SE and the drain electrode DE. The first passivation layer 1113 may include at least one of a silicon oxide (SiO_{X}) and a silicon nitride (SiN_{X}).

An organic layer 1114 may be formed on the first passivation layer 1113. The organic layer 1114 may planarize an upper surface of the display panel 1100 so that a problem due to an uneven upper surface such as a cut off of a signal wiring may be prevented. The organic layer 1114 may be an insulation layer including an organic material.

The pixel electrode PE may be formed on the organic layer 1114. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium. The pixel electrode PE may be electrically connected to the drain electrode DE through a first contact hole CNT1.

A second passivation layer 1116 may be formed on the pixel electrode PE. The second passivation layer 1116 may include at least one of a silicon oxide (SiO_{X}) and a silicon nitride (SiN_{X}).

The common electrode CE may be formed on the second passivation layer 1116. The common electrode CE may overlap the pixel electrode PE. The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium. The common electrode CE may be electrically connected to a common line CL through a second contact hole CNT2.

The data metal pad DMP may be electrically connected to the data metal pattern. The data metal pad DMP may be electrically connected to the touch driver 1405 through the first connecting line 1410. The first connecting line 1410 may be electrically connected to the main flexible printed circuit board 1140. The main flexible printed circuit board 1140 may be electrically connected to the data metal pad DMP in a process of chip on glass (“COG”). However, the present disclosure is not limited thereto, and the first connecting line 1410 may be connected to the data metal pad DMP in various methods.

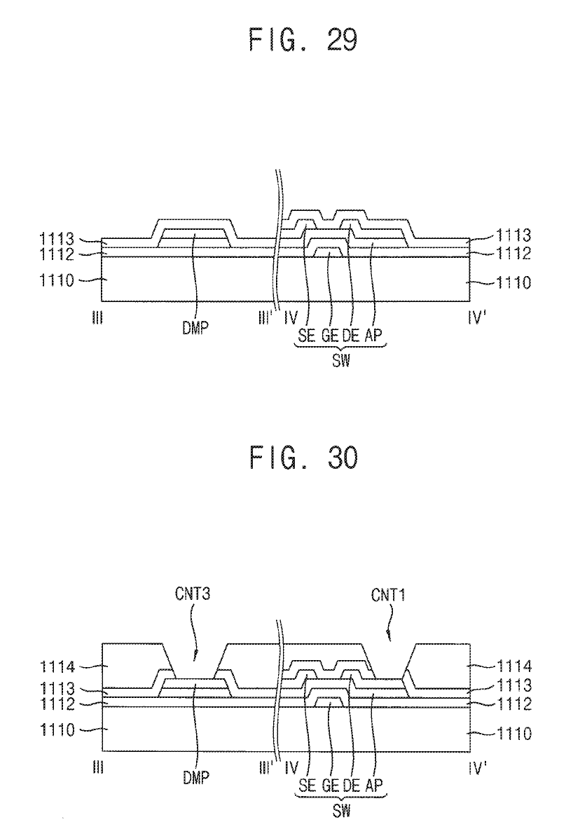

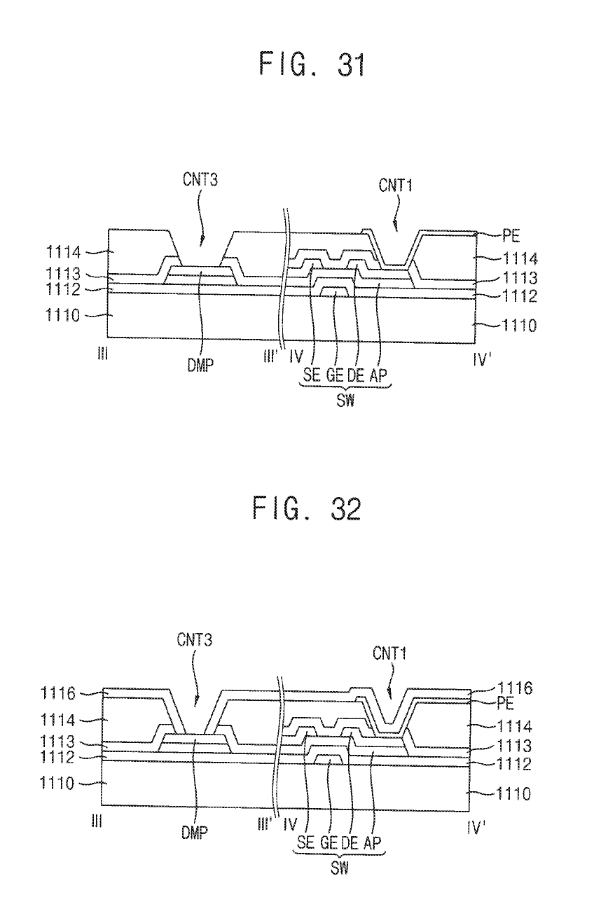

FIGS. 28 to 32 are cross-section views illustrating a method of manufacturing the display panel 1100 of FIG. 26.

Referring to FIG. 28, the gate electrode GE and the gate insulating layer 1112 are formed on the base substrate 1110.

The base substrate 1110 may be one of a glass substrate, a quartz substrate, a silicon substrate and a plastic substrate.

The gate electrode GE may include copper (Cu), silver (Ag), chromium (Cr), molybdenum (Mo), aluminum (Al), titanium (Ti), manganese (Mn), or an alloy thereof. The gate electrode GE may include a single layer. The gate electrode GE may include plural layers including different metals.

The gate insulating layer 1112 may be formed on the base substrate 1110 on which the gate electrode GE is formed. The gate insulating layer 1112 may include silicon oxide (SiO_{X}) or silicon nitride (SiN_{X}).

Referring to FIG. 29, the active pattern AP, the source electrode SE, the drain electrode DE and the first passivation layer 1113 are formed on the base substrate 1110 on which the gate insulating layer 1112 is formed.

The active pattern AP may be formed on the gate insulating layer 1112. The active pattern AP may be formed in an area the gate electrode GE is formed. The active pattern AP may overlap the gate electrode GE. The active pattern AP may partially overlap the source electrode SE and the drain electrode DE. The active pattern AP may be disposed between the gate electrode GE and the source electrode SE. The active pattern AP may be disposed between the gate electrode GE and the drain electrode DE. The source electrode SE and the drain electrode DE may include copper (Cu), silver (Ag), chromium (Cr), molybdenum (Mo), aluminum (Al), titanium (Ti), manganese (Mn), or an alloy thereof. The source electrode SE and the drain electrode DE may include a single layer. The source electrode SE and the drain electrode DE may include plural layers including different metals. For example, the source electrode SE and the drain electrode DE may include a copper (Cu) layer and a titanium (Ti) layer disposed on or under the copper (Cu) layer.

The data metal pad DMP may include copper (Cu), silver (Ag), chromium (Cr), molybdenum (Mo), aluminum (Al), titanium (Ti), manganese (Mn), or an alloy thereof. The data metal pad DMP may include a single layer. The data metal pad DMP may include plural layers including different metals. For example, the data metal pad DMP may include a copper (Cu) layer and a titanium (Ti) layer disposed on or under the copper (Cu) layer.

The first passivation layer 1113 may include a material substantially the same as the material of the gate insulating layer 1112. For example, the first passivation layer 1113 may include at least one of a silicon oxide (SiO_{X}) and a silicon nitride (SiN_{X}).

Referring to FIG. 30, the organic layer 1114 is formed on the base substrate 1110 on which the first passivation layer 1113 is formed. The organic layer 1114 may planarize an upper surface of the display panel 1100 so that a problem due to an uneven upper surface such as a cut off of a signal wiring may be prevented. The organic layer 1114 and the first passivation layer 1113 may be patterned to form the first contact hole CNT1 and a third contact hole CNT3.

The first contact hole CNT1 may expose a portion of the drain electrode DE. The third contact hole CNT3 may expose a portion of the data metal pad DMP.

Referring to FIG. 31, the pixel electrode PE may be formed on the base substrate 1110 on which the first contact hole CNT1 and the third contact hole CNT3 are formed.

The pixel electrode PE may be electrically connected to the drain electrode DE through the first contact hole CNT1. The pixel electrode PE may include a transparent and conductive material. For example, the pixel electrode PE may include indium tin oxide (ITO) or indium zinc oxide (IZO). Alternatively, the pixel electrode PE may include titanium (Ti) or an alloy (MoTi) of molybdenum and titanium.

Referring to FIG. 32, the second passivation layer 1116 is formed on the base substrate 1110 on which the pixel electrode PE is formed. The second passivation layer 1116 may be patterned to generate the third contact hole CNT3 exposing the portion of the data metal pad DMP.

The second passivation layer 1116 may include a material substantially the same as the material of the first passivation layer 1113. For example, the second passivation layer 1116 may include at least one of a silicon oxide (SiO_{X}) and a silicon nitride (SiN_{X}).

The data metal pad DMP may be electrically connected to the data metal pattern. The data metal pad DMP may be electrically connected to the touch driver 1405 through the first connecting line 1410. The first connecting line 1410 may be electrically connected to the main flexible printed circuit board 1140. The main flexible printed circuit board 1140 may be electrically connected to the data metal pad DMP in a process of chip on glass (“COG”). However, the present disclosure is not limited thereto, and the first connecting line 1410 may be connected to the data metal pad DMP in various methods.

Referring to FIG. 27, the common electrode CE is formed on the base substrate 1110 on which the second passivation layer 1116 is formed.

The common electrode CE may include a transparent and conductive material. For example, the common electrode CE may include indium tin oxide (ITO) or indium zinc oxide (IZO). Alternatively, the common electrode CE may include titanium (Ti) or an alloy (MoTi) of molybdenum and titanium.

According to the present exemplary embodiment, the first connecting line 1410 of the touch controller 1400 may electrically connect the gate metal pattern or the data metal pattern formed on the display panel 1100 to the touch driver 1405. In addition, the second connecting line 1420 may electrically connect the reflective sheet 1241 to the touch driver 1405. The metal pattern formed on the display panel 1100 may be spaced apart from the reflective sheet 1241 in a predetermined distance. Accordingly, the touch driver 1405 may sense the change of the capacitance due to the change of the distance between the reflective sheet 1241 and the gate metal pattern or the data metal pattern formed on the display panel 1100.

Therefore, the thickness of the touch display apparatus may decrease and the manufacturing cost of the touch display apparatus may be reduced.

According to the exemplary embodiments explained above, the touch display apparatus includes a touch controller including a touch driver, a first line and a second line, the first connecting line electrically connects the gate metal pattern or the data metal pattern formed on the display panel to the touch driver, and the second connecting line electrically connects the receiving container or the reflective sheet to the touch driver. Accordingly, the touch driver may sense the change of the capacitance due to the change of the distance between the receiving container or the reflective sheet and the gate metal pattern or the data metal pattern formed on the display panel.

Therefore, an additional electrode to sense a pressure may be omitted so that the thickness of the touch display apparatus may decrease and the manufacturing cost of the touch display apparatus may be reduced.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch display apparatus comprising:
a display panel comprising a metal pattern comprising a gate metal pattern and a data metal pattern, wherein
the gate metal pattern comprises a gate line extending in a first direction and a gate electrode electrically connected to the gate line,
the data metal pattern comprises a data line extending in a second direction crossing the first direction,
a source electrode is electrically connected to the data line and a drain electrode spaced apart from the source electrode, and
the display panel configured to display an image;
a receiving container receiving the display panel and comprising a metal; and
a touch controller comprising a first connecting line electrically connected to the metal pattern and a second connecting line electrically connected to the receiving container, wherein the touch controller is configured to sense a change of capacitance due to a change of a distance between the metal pattern and the receiving container.

2. The touch display apparatus of claim 1, wherein the first connecting line is electrically connected to the gate metal pattern.

3. The touch display apparatus of claim 2, further comprising a backlight assembly disposed between the display panel and the receiving container.

4. The touch display apparatus of claim 3, wherein the backlight assembly comprises:
a light source part configured to provide light to the display panel; and
a light guide plate configured to guide the light provided from the light source part.

5. The touch display apparatus of claim 4, further comprising:
a diffusing sheet disposed on the light guide plate and configured to diffuse the light exited from the light guide plate; and
a prism sheet configured to condense the light exiting from the diffusing sheet.

6. The touch display apparatus of claim 1, wherein the first connecting line is connected to the data metal pattern.

7. The touch display apparatus of claim 6, further comprising a backlight assembly disposed between the display panel and the receiving container.

8. The touch display apparatus of claim 7, wherein the backlight assembly comprises:
a light source part configured to provide light to the display panel; and
a light guide plate configured to guide the light provided from the light source part.

9. The touch display apparatus of claim 8, further comprising:
a diffusing sheet disposed on the light guide plate and configured to diffuse the light exited from the light guide plate; and
a prism sheet configured to condense the light exited from the diffusing sheet.

10. The touch display apparatus of claim 1, wherein the change of capacitance due to the change of a distance between the metal pattern and the receiving container is determined by following equation:
C=ε*A/d,
wherein C is the capacitance, A is an area of sensing the capacitance, ε is permittivity of free air space, and d is the distance between the metal pattern and the receiving container.

11. A touch display apparatus comprising:
a display panel comprising a metal pattern comprising a gate metal pattern and a data metal pattern, wherein
the gate metal pattern comprises a gate line extending in a first direction and a gate electrode electrically connected to the gate line,
the data metal pattern comprises a data line extending in a second direction crossing the first direction,
a source electrode is electrically connected to the data line and a drain electrode spaced apart from the source electrode, and
the display panel configured to display an image;
a reflective sheet disposed under the display panel wherein the reflective sheet spaced apart from the display panel and the reflective sheet comprises a metal; and
a touch controller comprising a first connecting line electrically connected to the metal pattern and a second connecting line electrically connected to the reflective sheet, wherein
the touch controller is configured to sense a change of capacitance due to a change of a distance between the metal pattern and the reflective sheet.

12. The touch display apparatus of claim 11, wherein the first connecting line is electrically connected to the gate metal pattern.

13. The touch display apparatus of claim 12, further comprising a backlight assembly disposed between the display panel and the reflective sheet.

14. The touch display apparatus of claim 13, wherein the backlight assembly comprises:
a light source part configured to provide light to the display panel; and
a light guide plate configured to guide the light provided from the light source part.

15. The touch display apparatus of claim 14, further comprising:
a diffusing sheet disposed on the light guide plate and configured to diffuse the light exited from the light guide plate; and
a prism sheet configured to condense the light exiting from the diffusing sheet.

16. The touch display apparatus of claim 11, wherein the first connecting line is connected to the data metal pattern.

17. The touch display apparatus of claim 16, further comprising a backlight assembly disposed between the display panel and the reflective sheet.

18. The touch display apparatus of claim 17, wherein the backlight assembly comprises:
a light source part configured to provide light to the display panel; and
a light guide plate configured to guide the light provided from the light source part.

19. The touch display apparatus of claim 18, further comprising:
a diffusing sheet disposed on the light guide plate and configured to diffuse the light exited from the light guide plate; and
a prism sheet configured to condense the light exited from the diffusing sheet.

20. The touch display apparatus of claim 11, wherein the change of capacitance due to the change of a distance between the metal pattern and the reflective sheet is determined by following equation:
C=ε*A/d,
wherein C is the capacitance, A is an area of sensing the capacitance, ε is permittivity of free air space, and d is the distance between the metal pattern and the reflective sheet.
